(19) United States
(12) Patent Application Publication
(10) Pub. No.: US 2013/0078698 A1
(43) Pub. Date: Mar. 28, 2013

(54) PROCESS FOR FRACTIONATION OF BIOMASS

(71) Applicants: Arvind Mallinath Lali, Mumbai (IN); Jayesh Suman Varavadekar, Mumbai (IN); Prathamesh Chandrashekhar Wadekar, Mumbai (IN)

(72) Inventors: Arvind Mallinath Lali, Mumbai (IN); Jayesh Suman Varavadekar, Mumbai (IN); Prathamesh Chandrashekhar Wadekar, Mumbai (IN)

(21) Appl. No.: 13/702,480

(22) PCT Filed: Sep. 21, 2010
(86) PCT No.: PCT/IN2010/000634

§ 371 Date: Dec. 6, 2012

(30) Foreign Application Priority Data
Jun. 10, 2010 (IN) 1762/MUM/2010

(51) Int. Cl. C08B 15/08

(52) U.S. Cl. CPC C08B 15/08
USPC 435/165; 127/65; 127/37; 585/240; 568/716; 568/426

(57) ABSTRACT

A process of fractionation of biomass using aqueous ammonia for fractionation of biomass into lignin, cellulose and/or hemicellulose is provided herein. The process disclosed in the present invention is recovers lignin, cellulose and hemicellulose in more than 90% purity. The present invention also provides process of saccharification and fermentation of biomass using aqueous ammonia for production of soluble sugars, alcohols, acids, phenols and other desired products, or derivatives thereof. The process disclosed in the present invention is robust, cost effective and scalable.

### FIELD OF INVENTION

The present invention relates to the field of fractionation and/or processing of biomass for production of various platform compounds, products and/or by-products.

### BACKGROUND OF THE INVENTION

The general trend of rising crude oil prices and the uncertainty over its adequate supply during the course of the next few decades has driven the search for alternative fuel and chemical feedstocks. Biomass more specifically lignocellulosic biomass (henceforth referred as LBM) is one such feedstock which promises sustainability.

LBM constitutes 50% of the total biomass in the world. It occurs in abundance as industrial waste (paper industry), forestry waste, municipal solid waste and agricultural waste. However, a much larger source of LBM is agricultural produce. Bulk of the agricultural residue after harvesting products like grains, pulses, and other products like cotton, oil seeds etc. finds little use and is mostly abandoned to decay or burned directly to provide primary energy.

Lignocellulosic biomass mainly is made up of sugar polymers cellulose and hemicellulose as structural components of the plant cell wall along with lignin, a component that acts as binding cement in cross linking the polymers. Lignin is a phenolic macromolecule that plays an important role in conducting water in plants. Further, cross linking of lignin with other cell wall components minimizes the accessibility of cellulose and hemicellulose to microbial cellulolytic enzymes thus conferring protection against pests and pathogens.

Cellulose is a linear polymer which consists of thousands of molecules of glucose linked by β (1,4)-glycosidic bonds. The linearity of glucose chains in cellulose results in extensive inter-chain hydrogen bonding, conferring a degree of crystallanity thus providing rigidity to the polymer. Hemicellulose on the other hand is a branched polymer containing hexose sugar residues such as D-Galactose, D-Mannose, D-Glucose, L-Galactose, L-Rhamnose in addition to pentose sugar residues like D-Xylose and L-Arabinose, and uronic acids such as D-Glucuronic acid.

Depending on the plant species and the cell type, the content of hemicellulose, cellulose and lignin in a LBM varies from 35 to 50% cellulose, 20 to 35% hemicellulose, and 10 to 25% lignin. It is amply reported that the close crystalline nature of cellulose and its association with hemicellulose and lignin makes it resistant to chemical and enzymatic hydrolysis.

Being the largest renewable feedstock on earth, LBM can serve as a valuable feedstock for energy, fuels and chemicals. Primary energy can be derived from LBM by direct combustion and a large amount of efforts have been directed at this aspect of bioenergy the world over. However, fuels and chemicals derived from LBM offer far higher returns and form an important aspect of fuel and chemical industry in the decades to come. In order to utilize LBM as platform for fuels and chemicals, it is necessary to break down LBM into the monomeric forms of its polymeric constituents namely, cellulose, hemicelluloses and lignin.

Lignin, cellulose and hemicellulose can be hydrolyzed into corresponding oligomeric or monomeric forms like phenol derivatives, and sugars like glucose, xylose, arabinose, etc., which can serve as platform molecules based on which a plethora of alternative fuels like ethanol, butanol, methane; and chemicals like lactic acid, succinic acid, levulinic acid, furfural derivatives, functional phenolic polymers etc. can be derived.

Two different approaches have been adopted worldwide in development of technologies for conversion of LBM to fuels and/or chemicals. By and large, the first major step involves a process in which the ‘tight and impervious’ nature of LBM is ‘loosened up’ using some form of physical, chemical, or physico-chemical treatment step which is generally called as ‘pre-treatment’ process. In one approach the LBM is subjected to the pre-treatment step and the resulting biomass is subjected to chemical or bio-chemical conversion processes that convert the combined components of the pre-treated LBM to desired products. In the second approach, the LBM is subjected to the ‘pre-treatment’ step in such a way as to result in separation or fractionation of the LBM into two or three streams or fractions comprising the components namely, cellulose, hemicelluloses and lignin in different proportions so as to make them amenable to next step of chemical and/or biochemical conversions.

The primary objective of the pre-treatment process is to improve enzymatic hydrolysis for production of sugars from cellulose and subsequent fermentation of sugars to ethanol. Various physico-chemical-thermal methods such as acid hydrolysis, hydrothermal pretreatment, autohydrolysis, steam explosion, wet explosion, delignification pretreatments, alkaline treatments, lime and NaOH pretreatments, ammonia fiber explosion (AFEX), and ammonia Recycling percolation (ARP) have been developed as pretreatment technologies for biomass (Sanchez and Cardona, Bioresource Technology 99 (2008), 5270-5295; Florbela Carvallheiro, Luis C. Duarte and Francisco M Girio, 2008, Journal of Scientific and Industrial Research, 67, (2008) 849-864).

A number of variants of each of these methods have been reported with associated advantages and disadvantages. While ionic liquid treatment is still in research stage, it is generally accepted that though acid and hydrothermal treatments like dilute sulfuric acid treatment and steam explosion, respectively are cheaper options there is an associated loss of resulting sugars and formation of by-products that affect the performance of downstream processes like enzymatic reactions and fermentations.

Both sodium hydroxide and ammonia have been attempted for LBM alkali pre-treatment. Use of sodium hydroxide is widely reported and used for production of paper from LBM. The large amount of sodium hydroxide used makes it mandatory that the alkali is recycled. The associated high cost of alkali recycle is absorbed into the cost of paper produced. However, production of a low cost product like biofuel makes the use of sodium hydroxide an un-economical option. Ammonia on the other hand is a gaseous substance and is more easily recoverable and use of ammonia has also been known to result in desired pre-treatment. Ammonia fiber explosion (AFEX) technology has been reported for LBM pre-treatment, but like steam-explosion process, it does not produce separate streams of LBM components namely, cellulose, hemicelluloses and lignin. Pre-treatment of LBM with ammonia is the mildest of the pre-treatment processes and results in high quality of biomass with respect to its further conversion to sugars by enzymes without the formation of inhibitors. The low corrosiveness of ammonia in comparison with acids also favors its use at an industrial scale. Ammonia being volatile, also offers ease of recovery compared to other pretreatment agents like aqueous alkali and ionic liquids.

Bishop C. T. and Adams G. A. (Canadian Journal of Research, B, 28 (1950) 753) describe the swelling action which anhydrous liquid ammonia has on wheat straw which after pressure release and washing of the biomass delignifies the cellulose and hemicellulose. They found that anhydrous liquid ammonia in a high pressure batch contact essentially physically swells the cellulose fibers present in wheat straw which loosens the wheat straw and increase its accessibility to solvents further used to remove the liquid anhydrous ammonia and soluble materials generated in the wheat straw. Though reported much earlier, the process is similar to AFEX process reported and patented later.

Bishop C. T. (Canadian Journal of Chemistry, 30 (1952), 4) describes action of anhydrous liquid ammonia on wheat straw holocellulose (cellulose+hemicellulose) and extraction with anhydrous liquid ammonia that removes 8% of wheat straw holocellulose. The document further describes that anhydrous liquid ammonia is not a good solvent for extraction polyuronide material.

Kim and Lee (Bioresource Technology 96 (2005) 2007-2013) describe Ammonia Recycle Percolation (ARP) process comprising pretreatment of corn stover with aqueous ammonia at 170° C. for 10 min. to 90 min. followed by a hot water treatment. ARP essentially comprises percolating aqueous ammonia solution through a bed of particulate biomass in a vertical column or tank. The paper describes hot water treatment percolation followed by ARP that results in removal of hemicellulose in the first step of hot water, and then lignin in ARP step. This two stage process was reported to obtain 84% xylan (hemicellulose) in first stage, and 75% lignin in second stage. The process as described removes lignin to an extent reported from the biomass and also does not remove hemicellulose completely from cellulosic residue. Teymouri et al (Bioresource Technology 96 (2005) 2014-2018) describe the ammonia fiber exploxion (AFEX) treatment of corn stover to enhance the digestibility of biomass, and the reported method comprises treatment of biomass with liquid anhydrous ammonia at moderate temperature and high pressure for few minutes after which pressure is rapidly released. The process results in cleavage of lignin-carbohydrate complex, and cellulose de-crystallization that leads to an increased surface area of biomass for next step saccharification. In this reported AFEX process the components namely lignin, hemicellulose and cellulose remain unseparated to be subjected to further process to produce fermentable sugars.

Ko et al. (Bioresource Technology 100 (2009) 4374-4380) describe a process of disruption and removal of lignin by aqueous ammonia pre-treatment of rice straw to enhance the enzymatic digestibility of the rice straw. The processes described comprises soaking of rice straw in aqueous ammonia (12-28% w/w) at 50° C. to 70° C. for 4-10 hours to remove lignin by filtering the pretreated rice straw. The process does not fractionate cellulose and hemicellulose and further comprises vacuum drying the biomass obtained after the process at 45° C. for more than 3 days and storing at −70° C. until further use. Saccharification and fermentation of the solid slurry was carried out to produce ethanol.

Kim et al (Bioresource Technology 99 (2008) 5206-5215) describe a combination of controlled pH liquid hot water pretreatment (LHW) and ammonia fiber explosion (AFEX) treatment of distiller's grain. The method described by Kim et al improves enzymatic digestibility of the distiller's dried grains with solubles (DDGS) resulting in 90% cellulose conversion to glucose within 24 hours of hydrolysis.

Li et al (Bioresource Technology, 2009) describe ammonia fiber explosion (AFEX) treatment of forage and sweet sorghum bagasse for production of ethanol.

(U.S. Pat. No. 5,037,663) describes a process for increasing the reactivity of cellulose containing material, increasing the extraction of proteins from within the cells which make up animal feedstuff material and increasing water holding capacity of cellulose containing material. The process described comprises treating the biomass with liquid ammonia and applying pressure of about 150 to 500 psia. The pressure is then rapidly reduced to atmospheric pressure. The process results in the treated biomass wherein lignin, cellulose and hemicellulose remain within the biomass. This process came to be later known as AFEX.

Another patent application US20080008783 describes a process of pretreatment of a lignocellulosic biomass with combinations of water and/or heat and/or anhydrous ammonia and/or concentrated ammonium hydroxide and/or ammonia gas to increase the reactivity of structural carbohydrates such as cellulose and hemicellulose within the biomass towards action of celluloytic enzymes.

Processes described in U.S. Pat. No. 5,037,663 and US20080008783 are basically biomass pretreatment processes and do not attempt to fractionate the biomass into its components such as lignin, cellulose and hemicellulose.

Patent applications US20070031918, US20070031953 and US20090053770 describe a process of saccharification of low concentration aqueous ammonia (less than 2% v/v) pretreated biomass to produce fermentable sugars using saccharification enzyme consortium, and their further conversion to ethanol. Patent application also describes a process of ethanol production from ammonia (less than 2% v/v) pretreated biomass to produce fermentable sugars using saccharification enzyme consortium and biocatalyst. The patent application describes a process for preparation of an improved pretreated biomass product (using 2% v/v ammonia), wherein the improved biomass was produced by filtering and removing the biomass pretreated liquor, and the biomass subjected to further process. There is no attempt to describe any fractionation of biomass to its components namely, cellulose, hemicellulose and lignin.

From the reported prior art it becomes clear that the use of ammonia has been reported for pre-treatment of biomass mainly as two processes namely, Ammonia Fibre Explosion (AFEX) process or Ammonia Percolation (ARP) process. Other reports on the other hand, use ammonia at less than 30% concentartions and only attempt to loosen the LBM structure for subsequent enzyme hydrolysis. Further, the main result and purpose of all reported processes is not fractionation of biomass but obtaining a biomass in the form and nature such that it can be used for enzyme hydrolysis and/or fermentation. Thus, the processes reported do not result in separation of the biomass into THREE distinct components namely cellulose, hemicellulose and lignin, even though partial separations good enough for enzyme hydrolysis or fermentation have been reported. In effect, the process of pretreatment of biomass as described in the prior arts emphasizes on making the treated biomass amenable to hydrolysis by cellulolytic enzymes to obtain sugars and their further conversion to ethanol. In all of the prior art lignin, cellulose and hemicellulose are not separated from any LBM as three fractions with use of aqueous ammonia as an exclusive reagent. The prior art processes thus do not aim at or involve fractionation of biomass.

None of the prior art, therefore, discloses any process of fractionation of biomass to obtain substantially pure cellulose, hemicellulose and/or lignin in high yields (>85%) and that can be further processed individually for the production of various compounds such as sugars, ethanol, butanol, lactic acid, furfural, phenols and various other biochemical or chemical products or derivatives thereof. In view of the potential of using biomass as a source of platform compounds for chemical or biochemical synthesis of chemicals, fuels and many other derivatives thereof, there is a need of a novel, commercially feasible and cost effective process that results in production of good quality cellulose, lignin and hemicellulose in high yields and which can be further used for production of sugars, alcohols and various other desired compounds through biological or chemical transformations. The present invention provides an efficient, scalable, cost effective and robust process for fractionation of biomass into lignin, cellulose and hemicellulose for production of sugars, alcohols and other desired products.

### SUMMARY OF THE INVENTION

One aspect of the present invention provides a process of fractionation of biomass to obtain lignin, cellulose and hemicelluloses, the process comprises contacting the biomass with 5% to 30% (v/v) aqueous ammonia at a temperature ranging from 50° C. to 200° C. to obtain a first biomass slurry; filtering the first biomass slurry to obtain a first filtrate comprising lignin and a first residue comprising cellulose and hemicellulose; contacting the first residue with 30% to 90% (v/v) aqueous ammonia at a temperature ranging from 50° C. to 200° C. time to obtain a second biomass slurry; and filtering the second biomass slurry to obtain a second filtrate comprising hemicelluloses and a second residue comprising cellulose

Another aspect of the present invention provides a process of fractionation of biomass to obtain cellulose and hemicelluloses, the process comprises contacting the biomass with 5% to 90% (v/v) aqueous ammonia at a temperature ranging from 50° C. to 200° C. to obtain a biomass slurry; and filtering the biomass slurry to obtain a filtrate comprising hemicellulose and a residue comprising cellulose and/or hemicellulose.

Another aspect of the present invention provides a process of saccharification of biomass to produce soluble sugars, the process comprises
a) contacting the biomass with 5% to 30% (v/v) aqueous ammonia at a temperature ranging from 50° C. to 200° C. to obtain a first biomass slurry;
b) filtering the first biomass slurry to obtain a first filtrate comprising lignin and a first residue comprising cellulose and hemicellulose;
c) treating the first residue with 30% to 90% (v/v) aqueous ammonia at a temperature ranging from 50° C. to 200° C. to obtain a second biomass slurry;
d) filtering the second biomass slurry to obtain a second filtrate comprising hemicellulose and a second residue comprising cellulose; and
e) hydrolyzing the cellulose and hemicellulose obtained in step (d) to obtain soluble sugars.

Yet another aspect of the present invention provides a process of saccharification of biomass to obtain soluble sugars, the process comprises
a) contacting the biomass with 5% to 90% (v/v) aqueous ammonia at a temperature ranging from 50° C. to 200° C. to obtain a biomass slurry;
b) filtering the biomass slurry to obtain a filtrate comprising hemicellulose; and a residue comprising cellulose and/or hemicellulose, and
c) hydrolyzing cellulose and/or hemicellulose obtained in step (b) to obtain soluble sugars.

Further aspect of the present invention provides a process of production of desired compounds from biomass, the process comprises
a) contacting the biomass with 5% to 30% (v/v) aqueous ammonia at a temperature ranging from 50° C. to 200° C. for to obtain a first biomass slurry;
b) filtering the first biomass slurry to obtain a first filtrate comprising lignin and a first residue comprising cellulose and hemicellulose;
c) contacting the first residue with 30% to 90% (v/v) aqueous ammonia at a temperature ranging from 50° C. to 200° C. to obtain a second biomass slurry;
d) filtering the second biomass slurry to obtain a second filtrate comprising hemicelluloses and a second residue comprising cellulose;
e) hydrolyzing the cellulose and hemicellulose obtained in step (d) to obtain soluble sugars; and
f) converting the soluble sugars into desired compounds by chemical or biological means

Another aspect of the present invention provides a process of production of desired compounds from biomass, the process comprises
a) contacting the biomass with 5% to 90% (v/v) aqueous ammonia at a temperature ranging from 50° C. to 200° C. to obtain a biomass slurry;
b) filtering the biomass slurry to obtain a filtrate comprising hemicellulose; and a residue comprising cellulose and/or hemicellulose,
c) hydrolyzing cellulose and/or hemicellulose obtained in step (b) to obtain soluble sugars, and
d) converting the soluble sugars into desired compounds by chemical or biological means

### BRIEF DESCRIPTION OF ACCOMPANYING DRAWINGS

FIG. 1(A, B, C) shows set of HPLC chromatograms of the samples analyzed after the ammonia fractionation of rice straw. The injections to the HPLC were for solid biomass residues at different stages and analyzed using standard NREL LAP protocols for analysis of biomass. Cellulose, being entirely composed of glucose, the glucose concentration in the cellulosic biomass or its fractions can be taken as a measure of cellulose content in the biomass. Hemicellulose is majorly composed of xylose owing to its xylose backbone. Xylose or sugars other than glucose are absent in cellulose and hence the concentration of xylose in biomass of its fractions can be taken as a measure of hemicellulose. In each case (A, B and C of FIG. 1) the first prominent peak is of glucose (which is majorly from cellulose), the second and the third peaks are of xylose and arabinose respectively (which are exclusively from the hemicellulok component of rice straw). Note: ‘RT’ stands for ‘Retention Time’

FIG. 1-A represents analysis of initial rice straw and shows presence of cellulose (as glucose) and hemicellulose (as xylose+arabinose) in overall contents of 30% (w/w w.r.t to biomass) and 14% (w/w w.r.t to biomass), respectively. FIG. 1B represents analysis of first residue from rice straw after 30% (v/v) ammonia treatment and shows presence of hemicellulose (as xylose and arabinose peaks) in addition to glucose. The cellulose (glucose) content was over 95 w.r.t to initial cellulose (glucose) content in untreated rice straw. The hemicelluose (xylose+arabinose) content was found to be 85% w.r.t to the initial hemicellulose (xylose+arabinose) content in untreated rice straw.

FIG. 1-C represents analysis of second residue from rice straw after 60% (v/v) ammonia treatment and shows negligible hemicellulose (as small xylose peak). The cellulose (glucose) content is over 91% w.r.t to initial cellulose (glucose) content in untreated rice. Also the arabinose part of hemicellulose was not detected indicating satisfactory fractionation of biomass into cellulose and hemicellulose

FIG. 2 are photographs of the fractionated components from rice straw using the invented process. A—Rice straw initial (untreated) showing its fibrous nature; B—Cellulose from rice straw after ammonia fractionation seen as light in colour and having a smooth texture as compared to rice straw and; C—Hemicellulose obtained from rice straw after ammonia fractionation; and D—Lignin obtained from rice straw after ammonia fractionation.

FIG. 3 shows HPLC analysis of Hemicellulose obtained from rice straw showing Glucose (RT-12.7 min), Xylose (RT-13.6 min) and Arabinose (RT-16.1 min) peaks. Xylose (84% w/w total sugars) is the major component of rice straw hemicellulose followed by arabinose (16% w/w total sugars) and glucose (4% w/w total sugars).

FIG. 4 shows A—Rice straw initial (untreated), B—Cellulose from rice straw after ammonia fractionation showing lighter colour and superior texture as compared to C—Steam exploded cellulose which is darker in colour indicating some charring of biomass

FIG. 5 shows the time duration required for the fractionation of biomass using ammonia process. The total time required for conversion of biomass to ethanol as a direct result of the invented ammonia fractionation process (including pretreatment, saccharification and fermentation) is about 26 hours.

### DETAILED DESCRIPTION OF THE INVENTION

The term “Biomass” used herein refers any cellulosic or lignocellulosic material or any organic matter comprising lignin, hemicelluloses, cellulose or combinations thereof. It includes agricultural crops, crop residues, crop stalks, plants, plant residues, waste papers, industrial wastes, paper pulp, paper waste, cotton waste, rice straw, wheat straw, cotton straw, rice grains and bran, wheat grains and bran, corn cobs, grains and bran, grasses, corn husks, sorghum bagasse, sugarcane bagasse, fruits, vegetable, legume and cereal crops, wood chips, woody plants and algae.

The term “lignocellulosic” used herein refers to substance or organic matter comprising lignin and cellulose. The lignocellulosic biomass may comprise hemicellulose in addition to lignin and cellulose.

The term “cellulosic” used herein refers to substance or organic matter comprising cellulose; or cellulose and hemicellulose.

The term “fractionation” used herein refers to substantial separation and recovery of lignin, cellulose and hemicellulose from biomass.

The primary objective of the present invention is to provide an efficient, cost effective, and reproducible process for fractionation of biomass into lignin, cellulose and hemicellulose for production of various compounds such as soluble sugars, sugar alcohols, acids, phenols, fuels and other desired products or derivatives thereof.

The present invention provides a process of fractionation of biomass (BM) into various components like lignin, cellulose(s) and/or hemicelluloses(s). The present invention provides a process for fractionation of biomass with aqueous ammonia, wherein cellulose, hemicellulose and/or lignin are fractionated from the said biomass that can be further used for production of various products such as fermentable sugars, ethanol, butanol, various organic acids, furfural, phenols and other compounds.

The present invention particularly provides a process for fractionation of biomass with aqueous ammonia which results in production of lignin, cellulose and hemicellulose as three different streams. The primary object of the present invention is recovery of each of cellulose, hemicellulose and/or lignin in more than 90% purity and in high yield so that each can serve as a precursor, or platform, for the production of valuable building blocks for fuels and chemicals. The present invention further provides a process of saccharification of biomass using aqueous ammonia. In addition, the present invention also provides a process of production of alcohols and various other desired products from biomass using aqueous ammonia.

The high purity of the fractions viz. Cellulose, Hemicellulose and Lignin produced by the process as disclosed in the present invention also ensures enhanced control and hence higher yields, lower degradation products over the reactions involved in the further processing of each of the fraction(s).

The processes of pretreatment of biomass for production of sugars and alcohol as described in the prior arts are very slow, some requiring more than a week just for the pretreatment step (excluding the saccharification and fermentation processes), produce toxic or inhibitory compounds, and results in low yield of desired compounds (e.g. sugars) as a mixture that cannot be separated easily, and presents problems like inhibition of enzymes and/or microorganisms used in downstream processes after pre-treatment.

The process of fractionation of biomass into lignin, cellulose, and hemicellulose as disclosed in the present invention is a robust, scalable, cost effective process for fractionation of biomass into lignin, cellulose and hemicellulose. The process of fractionation of biomass as disclosed in the present invention results in high yield of considerably pure lignin, cellulose and hemicellulose and does not produce any toxic or inhibitory compound. Surprisingly the process requires 1-120 minutes for fractionation of a structurally complex biomass into lignin, cellulose and hemicellulose resulting in highly economical process for commercial production of lignin, cellulose and hemicellulose that can save considerable amount of capital equipment and operating expenses. The lignin, cellulose and hemicellulose thus obtained can be further processed for production of soluble sugars, alcohols, acids, phenols, fuels and various other compounds.

The process of fractionation of biomass into lignin, cellulose and hemicellulose; process of saccharification of biomass and process production of some of the desired compounds from biomass as disclosed in the present invention can be performed in continuous or batch operation mode.

The specific features of the present invention that make it more advantageous than the prior arts are as follows
1) it fractionates the biomass into lignin, cellulose and hemicellulose as separate products
2) it produces substantially (more than 90%) pure lignin, cellulose and hemicellulose
3) it results in high yield (more than 85%) of each of lignin, cellulose and hemicellulose
4) does not produce toxic or inhibitory substances (for enzymes and/or microorganisms used in downstream processes)
5) it is less capital intensive due to low treatment time
6) it can be adapted as a throughout continuous process
7) it results in high sugar and alcohol yields
8) it produces low effluents
9) it is robust and scalable process
10) it results in substantial reduction in processing time
11) large scale commercial production of lignin, cellulose, hemicellulose, sugars, alcohols, acids, phenols and various other desired product is possible as the process as disclosed in the present invention are scalable.

Further the process of fractionation of biomass as disclosed in the present invention is biomass type independent and the mechanism of the process is same for all types of biomass.

Since the fractionation of biomass results in production of considerably pure lignin, cellulose and hemicellulose in different streams, the further down processing of lignin, cellulose and hemicellulose for example, saccharification and fermentation for production of desired compounds is easy and requires less time as compared to the processes known in the art.

The cellulose and hemicellulose obtained using the process as disclosed in the present invention is highly amenable to hydrolysis. The cellulose obtained after fractionation is ‘off-white’ in colour [much lighter in shade than the raw material used (from straw coloured to dark brown)] and has a much finer fibrous texture than the raw material used. The cellulose fibres are homogenous and form a highly fibrous intertwined mass when dried.

The hemicellulose can be precipitated and dried to obtain a fine powder which is light beige in color.

Lignin obtained using the invented process was thermo-chemically converted into functional phenols like syringaldehyde, benzoic acid and benzaldehyde which can be used as energy enhancing additives for furnace oil. Lignin can also be pyrolyzed or hydrothermally treated to produce bio-oil which is a potential petroleum substitute.

Cellulose thus obtained was further hydrolyzed into its oligomers i.e. cellodextrins; monomer i.e. glucose using acids for example sulfuric acid or enzymes such as cellulases. The monomer glucose was further converted into a variety of products like ethanol, butanol and citric acid by fermentation and sorbitol by chemical reduction.

Hemicellulose thus obtained was hydrolyzed into its constituent monomers such as xylose, arabinose and glucose by acid or enzymes such as hemicellulases. The monomers like xylose can be used for the production of ethanol by fermentation. Xylose can be chemically and/or biochemically converted to xylitol which is used as a non-cariogenic sweetner, and to furfural which is used as a solvent.

In accordance with the present invention in first embodiment there is provided a process of fractionation of biomass to obtain lignin, cellulose and hemicelluloses, the process comprises contacting the biomass with 5% to 30% (v/v) aqueous ammonia at a temperature ranging from 50° C. to 200° C. to obtain a first biomass slurry; filtering the first biomass slurry to obtain a first filtrate comprising lignin and a first residue comprising cellulose and hemicellulose; contacting the first residue with 30% to 90% (v/v) aqueous ammonia at a temperature ranging from 50° C. to 200° C. time to obtain a second biomass slurry; and filtering the second biomass slurry to obtain a second filtrate comprising hemicelluloses and a second residue comprising cellulose

Second embodiment of the present invention provides a process of fractionation of biomass to obtain cellulose and hemicelluloses, the process comprises contacting the biomass with 5% to 90% (v/v) aqueous ammonia at a temperature ranging from 50° C. to 200° C. to obtain a biomass slurry; and filtering the biomass slurry to obtain a filtrate comprising hemicellulose and a residue comprising cellulose and/or hemicellulose.

Third embodiment of the present invention provides a process of fractionation of biomass to obtain cellulose and hemicelluloses, the process comprises contacting the biomass with 5% to 90% (v/v) aqueous ammonia at a temperature ranging from 50° C. to 200° C. to obtain a biomass slurry; and filtering the biomass slurry to obtain a filtrate comprising hemicellulose and/or lignin and a residue comprising cellulose and/or hemicellulose.

Fourth embodiment of the present invention relates to the process of fractionation of biomass to obtain cellulose and hemicelluloses using aqueous ammonia as disclosed in the present invention, wherein pH of the biomass slurry is 8-14.

Fifth embodiment of the present invention relates to the process of fractionation of biomass to obtain lignin, cellulose and hemicelluloses using aqueous ammonia, wherein the lignin is precipitated with one or more polyelectrolyte selected from a group consisting of natural polymers, synthetic polymers and semi-synthetic polymers, electrolytes and acids.

Sixth embodiment of the present invention provides the electrolytes for precipitation of lignin, wherein the electrolyte is selected from a group consisting of anionic, cationic, non-ionic, organic, and inorganic compounds.

Seventh embodiment of the present invention provides the biomass for fractionation into lignin, cellulose and hemicellulose, wherein the biomass is selected from a group consisting of rice straw, wheat straw, cotton stalks, sugarcane bagasse, sorghum bagasse, corn cobs, corn stalks, corn stover, corn grains, corn plant, castor stalks, water hyacinth, forest waste, paper waste, and grasses, switch grass, elephant grass and Miscanthus corn grains, wheat grains, rice grains, maize grains, sorghum grains, pearl millet grains and rye grains.

Eighth embodiment of the present invention provides a process of fractionation of biomass to obtain cellulose and hemicelluloses, the process comprises contacting the biomass with 5% to 90% (v/v) aqueous ammonia at a temperature ranging from 50° C. to 200° C. to obtain a biomass slurry; and filtering the biomass slurry to obtain a filtrate comprising hemicellulose and a residue comprising cellulose and/or hemicellulose, wherein the biomass is non-lignocellulosic biomass

The non-lignocellulosic biomass is selected from a group consisting of paper, paper waste, microbial cell mass, macroalgae cell mass, and macroalgae biomass.

Ninth embodiment of the present invention provides a process of fractionation of biomass to obtain cellulose and hemicelluloses, the process comprises contacting the biomass with 5% to 90% (v/v) aqueous ammonia at a temperature ranging from 50° C. to 200° C. to obtain a biomass slurry; and filtering the biomass slurry to obtain a filtrate comprising hemicellulose and a residue comprising cellulose and/or hemicellulose, wherein the biomass is algae.

Tenth embodiment relates to the process of fractionation of biomass to obtain cellulose and hemicelluloses as disclosed in the present invention, wherein weight of the biomass is 0.5% to 25% (w/v) in the aqueous ammonia.

Eleventh embodiment relates to the process of fractionation of biomass to obtain cellulose and hemicelluloses as disclosed in the present invention, wherein the process comprises contacting the biomass with 5% to 90% (v/v) aqueous ammonia at a temperature ranging from 50° C. to 200° C. to obtain a biomass slurry, wherein retention time of the biomass in the aqueous ammonia is 1 to 120 minutes.

Twelfth embodiment relates to the process of fractionation of biomass to obtain cellulose and hemicelluloses as disclosed in the present invention, wherein the process comprises contacting the biomass with 5% to 90% (v/v) aqueous ammonia at a temperature ranging from 50° C. to 200° C. to obtain a biomass slurry, wherein retention time of the biomass in the aqueous ammonia is 5 to 30 minutes.

Thirteenth embodiment relates to a process of fractionation of biomass to obtain lignin, cellulose and hemicelluloses, the process comprises contacting the biomass with 5% to 30% (v/v) aqueous ammonia at a temperature ranging from 50° C. to 200° C. to obtain a first biomass slurry; filtering the first biomass slurry to obtain a first filtrate comprising lignin and a first residue comprising cellulose and hemicellulose; contacting the first residue with 30% to 90% (v/v) aqueous ammonia at a temperature ranging from 50° C. to 200° C. time to obtain a second biomass slurry; and filtering the second biomass slurry to obtain a second filtrate comprising hemicelluloses and a second residue comprising cellulose, wherein retention time of the first residue in the aqueous ammonia is 1 to 120 minutes, preferably 5 to 30 minutes.

Fourteenth embodiment of the present invention provides process of fractionation of biomass to obtain lignin, cellulose and hemicelluloses, the process comprises contacting the biomass with 5% to 30% (v/v) aqueous ammonia at a temperature ranging from 50° C. to 200° C. to obtain a first biomass slurry; filtering the first biomass slurry to obtain a first filtrate comprising lignin and a first residue comprising cellulose and hemicellulose; contacting the first residue with 30% to 90% (v/v) aqueous ammonia at a temperature ranging from 50° C. to 200° C. time to obtain a second biomass slurry; and filtering the second biomass slurry to obtain a second filtrate comprising hemicelluloses and a second residue comprising cellulose, wherein at least 90% lignin, at least 91% cellulose, and at least 85% hemicellulose is obtained from the biomass.

Fifteenth embodiment of the present invention provides a process of fractionation of biomass to obtain cellulose and hemicelluloses, the process comprises contacting the biomass with 5% to 90% (v/v) aqueous ammonia at a temperature ranging from 50° C. to 200° C. to obtain a biomass slurry; and filtering the biomass slurry to obtain a filtrate comprising hemicellulose and a residue comprising cellulose and/or hemicellulose, wherein at least 90% lignin, at least 91% cellulose, and at least 85% hemicellulose is obtained from the biomass.

Sixteenth embodiment of the present invention provides a process of saccharification of biomass to produce soluble sugars, the process comprises
a) contacting the biomass with 5% to 30% (v/v) aqueous ammonia at a temperature ranging from 50° C. to 200° C. to obtain a first biomass slurry;
b) filtering the first biomass slurry to obtain a first filtrate comprising lignin and a first residue comprising cellulose and hemicellulose;
c) treating the first residue with 30% to 90% (v/v) aqueous ammonia at a temperature ranging from 50° C. to 200° C. to obtain a second biomass slurry;
d) filtering the second biomass slurry to obtain a second filtrate comprising hemicellulose and a second residue comprising cellulose; and
e) hydrolyzing the cellulose and hemicellulose obtained in step (d) to obtain soluble sugars.

Seventeenth embodiment of the present invention provides a process of saccharification of biomass to obtain soluble sugars, the process comprises
a) contacting the biomass with 5% to 90% (v/v) aqueous ammonia at a temperature ranging from 50° C. to 200° C. to obtain a biomass slurry;
b) filtering the biomass slurry to obtain a filtrate comprising hemicellulose; and a residue comprising cellulose and/or hemicellulose, and
c) hydrolyzing cellulose and/or hemicellulose obtained in step (b) to obtain soluble sugars.

Eighteenth embodiment of the present invention relates to the process saccharification of biomass to produce soluble sugars using aqueous ammonia, wherein retention time of the biomass in the aqueous ammonia is 1 to 120 minutes, preferably 5 to 30 minutes.

Nineteenth embodiment of the present invention relates to the process saccharification of biomass to produce soluble sugars using aqueous ammonia, wherein the process comprises contacting the biomass with 5% to 30% (v/v) aqueous ammonia at a temperature ranging from 50° C. to 200° C. to obtain a first biomass slurry;
a) filtering the first biomass slurry to obtain a first filtrate comprising lignin and a first residue comprising cellulose and hemicellulose;
b) treating the first residue with 30% to 90% (v/v) aqueous ammonia at a temperature ranging from 50° C. to 200° C. to obtain a second biomass slurry;
c) filtering the second biomass slurry to obtain a second filtrate comprising hemicellulose and a second residue comprising cellulose; and
d) hydrolyzing the cellulose and hemicellulose obtained in step (d) to obtain soluble sugars
wherein retention time of the first residue in the aqueous ammonia is 1 to 120 minutes, preferably 5 to 30 minutes.

Twentieth embodiment of the present invention relates to the process saccharification of biomass to produce soluble sugars using aqueous ammonia, wherein the sugars are selected from a group consisting of glucose, xylose, arabinose, mannose, rhamnose, cellobiose, and cellodextrins.

Twenty-first embodiment of the present invention provides a process of production of desired compounds from biomass, the process comprises
a) contacting the biomass with 5% to 30% (v/v) aqueous ammonia at a temperature ranging from 50° C. to 200° C. for to obtain a first biomass slurry;
b) filtering the first biomass slurry to obtain a first filtrate comprising lignin and a first residue comprising cellulose and hemicellulose;
c) contacting the first residue with 30% to 90% (v/v) aqueous ammonia at a temperature ranging from 50° C. to 200° C. to obtain a second biomass slurry;
d) filtering the second biomass slurry to obtain a second filtrate comprising hemicelluloses and a second residue comprising cellulose;
e) hydrolyzing the cellulose and hemicellulose obtained in step (d) to obtain soluble sugars and
f) converting the soluble sugars into desired compounds by chemical or biological means

Twenty-second embodiment of the present invention relates to the process of production of desired compounds from biomass as disclosed in the present invention, further comprises converting lignin from step (b) into desired compounds using conventional methods

Twenty-third embodiment of the present invention provides a process of production of desired compounds from biomass, the process comprises
a) contacting the biomass with 5% to 90% (v/v) aqueous ammonia at a temperature ranging from 50° C. to 200° C. to obtain a biomass slurry;
b) filtering the biomass slurry to obtain a filtrate comprising hemicellulose; and a residue comprising cellulose and/or hemicellulose,
c) hydrolyzing cellulose and/or hemicellulose obtained in step (b) to obtain soluble sugars, and
d) converting the soluble sugars into desired compounds by chemical or biological means

Twenty-fourth embodiment of the present invention relates to the process of production of desired compounds from biomass, wherein the desired compound is selected from the group consisting of toluene, benzene, vanillin, hydrocarbons, cresols, phenols, ethanol, methanol, propanol, butanediol, isopropanol, butanol, iso-butanol, glycerol, erythritol, xylitol, sorbitol, furfural, hydroxymethyl furfural, furfuryl alcohol, acetic acid, lactic acid, propionic acid, 3-hydroxypropionic acid, butyric acid, gluconic acid, itaconic acid, citric acid, succinic acid, levulinic acid, glutamic acid, aspartic acid, methionine, lysine, glycine, arginine, threonine, phenylalanine, tyrosine, methane, ethylene and acetone.

Twenty-fifth embodiment of the present invention relates to the biological means for conversion of soluble sugars, wherein biological means is microbial and/or enzymatic biotransformation.

Twenty-sixth embodiment of the present invention relates to microbial biotransformation which is carried out by using microorganisms selected from the group consisting of yeast, bacteria and fungi.

Twenty-seventh embodiment of the present invention relates to microorganism used for biotransformation, wherein the microorganism is selected from a group consisting of E. coli, Saccharomyces cervisiae, Zymomonas mobilis, Pichia stiptis, Candida, Clostridium acetobutylicum, Acetobacter, Rhizopus oryzae, Lactobacillus, and Bacillus stearothermophilus.

One embodiment of the present invention relates to the process of fractionation of biomass into lignin, cellulose and hemicellulose using aqueous ammonia, wherein the ammonia is recycled by conventional methods.

The process of fractionation of biomass as disclosed in the present invention produces lignin, cellulose and hemicellulose in 1-120 minutes or 30 to 60 minutes or 5 to 15 minutes.

In another embodiment of the present invention there is provided a process of fractionation of biomass to obtain cellulose, hemicelluloses and lignin, the process comprises
a. mixing the biomass with aqueous ammonia having pH in the range of 8-14 at a temperature ranging from 50° C. to 200° C. for 1 minute to 120 minutes, to obtain a first biomass slurry, wherein concentration of the aqueous ammonia is in the range of 5% to 30% v/v;
b. filtering the first biomass slurry to obtain a first filtrate comprising lignin and a first residue comprising cellulose and hemicellulose;
c. treating the first residue with aqueous ammonia having pH in the range of 8-14 at a temperature ranging from 50° C. to 200° C. for 1 minute to 120 minutes to obtain a second biomass slurry; wherein concentration the aqueous ammonia is in the range of 30% to 90% v/v; and
d. filtering the second biomass slurry to obtain a second filtrate comprising hemicelluloses and a second residue comprising cellulose

In one embodiment of the present invention there is provided a process of fractionation of biomass to obtain cellulose, hemicelluloses and lignin, the process comprises
a. mixing the biomass with aqueous ammonia having pH in the range of 8-14 at a temperature ranging from 50° C. to 200° C. for 1 minute to 120 minutes, to obtain a first biomass slurry, and wherein the liquid ammonia concentration is maintained at 5 to 30% v/v;
b. removing ammonia from the first biomass slurry by any known means of evaporation;
c. filtering the first biomass slurry to obtain first filtrate comprising lignin and first residue comprising cellulose and hemicellulose;
d. treating the first residue with aqueous ammonia having pH in the range of 8-14 at a temperature ranging from 50° C. to 200° C. for 1 minute to 120 minutes, to obtain second biomass slurry; wherein the liquid ammonia concentration is maintained in the range 30% to 90% v/v;
e. removing ammonia from the second biomass slurry by any known means of evaporation; and
f. filtering the second biomass slurry to obtain second filtrate comprising hemicelluloses and second residue comprising cellulose;

In yet another embodiment of the present invention there is provided a process of fractionation of biomass to obtain cellulose, hemicelluloses and lignin, the process comprises mixing the biomass with aqueous ammonia having pH in the range of 8-14 at a′ temperature ranging from 50° C. to 200° C. for 1 minute to 120 minutes, to obtain a first biomass slurry, wherein concentration of the aqueous ammonia is in the range of 5% to 30% v/v; filtering the first biomass slurry to obtain a first filtrate comprising lignin and a first residue comprising cellulose and hemicellulose; treating the first residue with aqueous ammonia having pH in the range of 8-14 at a temperature ranging from 50° C. to 200° C. for 1 minute to 120 minutes to obtain a second biomass slurry; wherein concentration the aqueous ammonia is in the range of 30% to 90% v/v; and filtering the second biomass slurry to obtain a second filtrate comprising hemicelluloses and a second residue comprising cellulose; wherein weight of said biomass is 0.5% to 25% w/v of the aqueous ammonia.

In another embodiment of the present invention there is provided a process of fractionation of biomass to obtain cellulose, hemicelluloses and lignin using ammonia, wherein the concentration of the aqueous ammonia is 0.5% to 90% w/v and is maintained under pressure in the range of 1 bar to 110 bar.

In yet another embodiment of the present invention there is provided a process of fractionation of biomass to obtain cellulose, hemicelluloses and/or lignin, wherein the biomass and/or the first residue obtained in the reaction was treated aqueous ammonia having pH in the range of 8-14 at a temperature ranging from 50° C. to 200° C. for 30 minutes.

In yet another embodiment of the present invention there is provided a process of fractionation of biomass to obtain cellulose, hemicelluloses and lignin, the process comprises mixing the biomass with aqueous ammonia having pH in the range of 8-14 at a temperature ranging from 50° C. to 200° C. for 1 minute to 120 minutes, to obtain a first biomass slurry, wherein concentration of the aqueous ammonia is in the range of 5% to 30% v/v; filtering the first biomass slurry to obtain a first filtrate comprising lignin and a first residue comprising cellulose and hemicellulose; treating the first residue with aqueous ammonia having pH in the range of 8-14 at a temperature ranging from 50° C. to 200° C. for 1 minute to 120 minutes to obtain a second biomass slurry; wherein concentration the aqueous ammonia is in the range of 30% to 90% v/v; and filtering the second biomass slurry to obtain a second filtrate comprising hemicelluloses and a second residue comprising cellulose; wherein the process is a continuous or a batch process.

The process of fractionation of biomass to obtain cellulose, hemicelluloses and/or lignin as disclosed in the present invention recovers at least 85% lignin, at least 91% to 95% cellulose and at least 85% hemicellulose from the biomass.

Further, the process of fractionation of biomass to obtain cellulose, hemicelluloses and/or lignin as disclosed in the present invention does not produce compounds that inhibit the process or that may act inhibitors to cellulolytic enzymes and fermentation processes.

In one of the embodiment of the present invention there is provided a process of saccharification of the cellulose and/or hemicellulose to obtain sugars using enzymatic, microbial or chemical means.

In another embodiment of the present invention there is provided a process of sugar fermentation, wherein the sugars are fermented with yeast, bacteria or fungi.

In another embodiment of the present invention there is provided a process of sugar fermentation, wherein the sugars are fermented with microorganisms, wherein the micro-organisms are genetically modified.

In still yet another embodiment of the present invention there is provided a chemical or biological (microbial and enzymatic) process of converting sugars to other useful compounds.

In further embodiment of the present invention there is provided a chemical or biological (microbial and enzymatic) process of converting cellulose/hemicelluloses/lignin to other useful compounds.

The person skilled in the art will realize that it is necessary to perform washing of the residues obtained in various steps of the process of fractionation of biomass to increase yield of the desired compound in the filtrate.

Further it is obvious to one skilled in the art to apply various means to reduce the headspace in a closed vessel to increase the amount of total ammonia in liquid phase in closed vessel process during fractionation of biomass into lignin, cellulose and hemicellulose in batch mode. For example, by maintaining pressure in the headspace of the reactor by inclusion of an inert gas such as nitrogen, the amount of ammonia required for fractionation of biomass can be reduced. However this kind of exercise would not be necessary if no headspace is required for the reactor (either batch or continuous) to operate satisfactorily.

### EXAMPLES

The embodiments are further defined in the following Examples. It should be understood that these Examples, while indicating embodiments of the invention, are given by illustration only. From above discussion and these Examples, one skilled in the art can ascertain the essential characteristics of the embodiments, and without departing from the spirit and scope thereof, can make various changes and modifications of them to adapt to various usages and conditions. Thus, various modifications of the embodiments in addition to those shown and described herein will be apparent to those skilled in the art from the foregoing description. Such modifications are also intended to fall within the scope of the appended claims.

### Example 1

### Fractionation of Rice Straw into Cellulose, Hemicellulose and Lignin Using Aqueous Ammonia

### Batch Mode

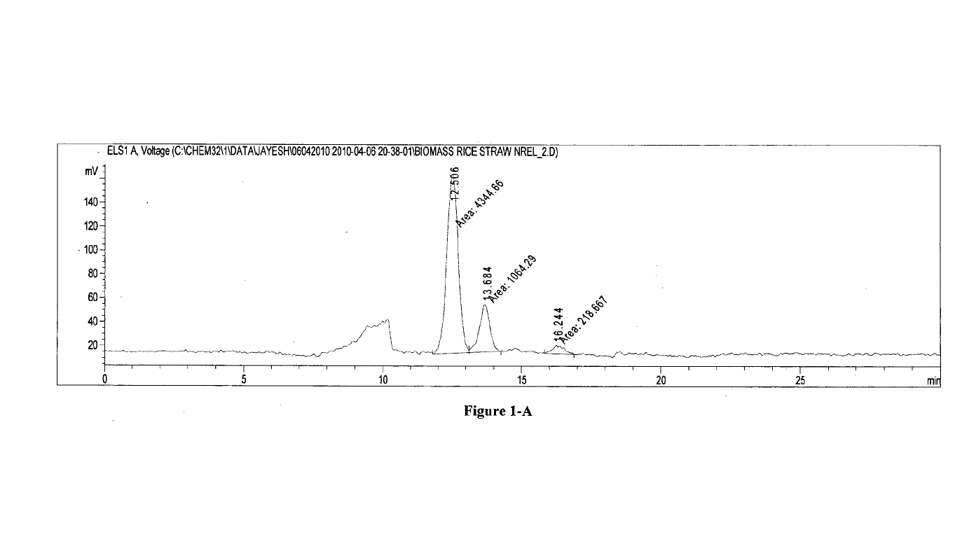

Size reduced rice straw (average 5 mm length; 3.5 g) was mixed with 100 ml of 30% v/v liquid ammonia in water, at 15° C. The resultant rice straw-ammonia slurry was charged into a high pressure reactor. The reaction was carried out in the reactor vessel at 125° C. for 30 minutes to obtain first slurry. Temperature of the first slurry was reduced to at least 95° C. and subsequently the slurry was filtered to obtain a first filtrate comprising lignin and a first residue comprising cellulose and hemicellulose. The first residue thus obtained was treated with 60% v/v liquid ammonia in water at 125° C. for 30 minutes to obtain the second slurry. Temperature of the second slurry was reduced to at least 95° C. and the subsequently the slurry was filtered to obtain a second filtrate comprising hemicelluloses and a second residue comprising cellulose (FIGS. 1, 2 and 4). The results of the aqueous ammonia fractionation process are depicted in FIGS. 1, 2, 3 and 4 and Tables 1 and 2. Compositional analysis of biomass residues in different stages of ammonia fractionation reveals the sequence in which the major components in the rice straw (lignin, cellulose and hemicellulose) separate from each other. Rice straw when subjected to 30% (v/v) ammonia fractionated into two streams: a liquid stream comprising lignin and a solid residue comprising cellulose and hemicellulose. The solid residue when subjected to 60% (v/v) ammonia treatment further fractionates into a liquid stream comprising hemicellulose and a solid residue comprising of cellulose (FIG. 1).

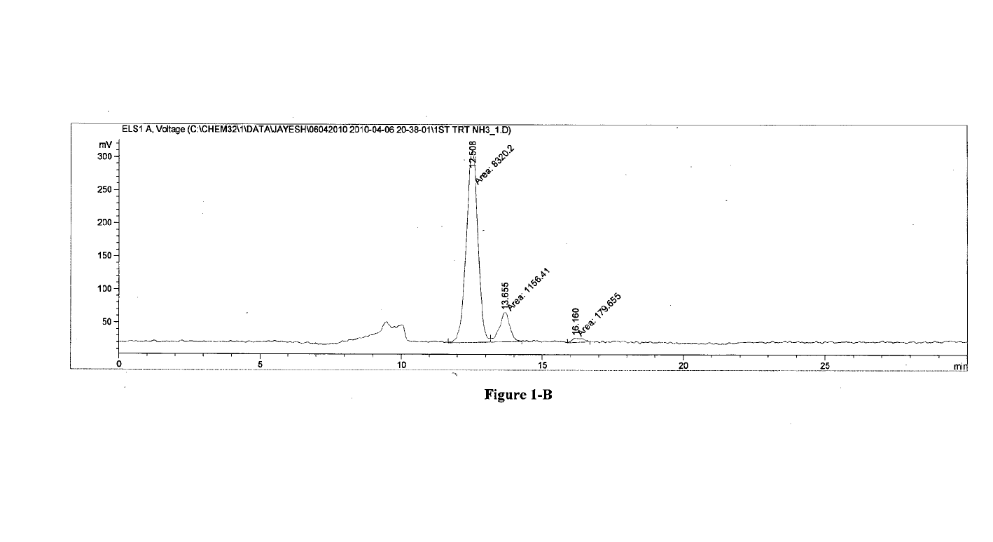

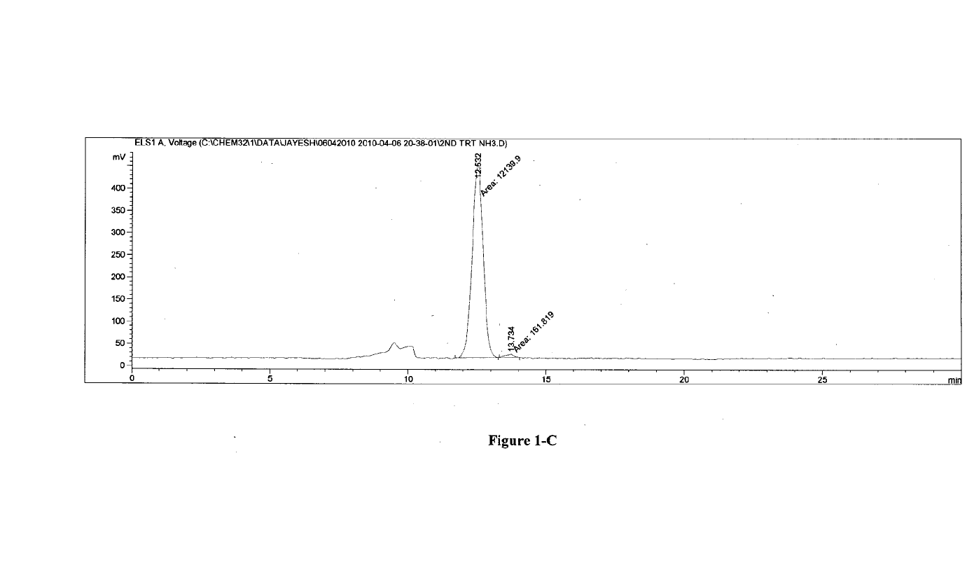

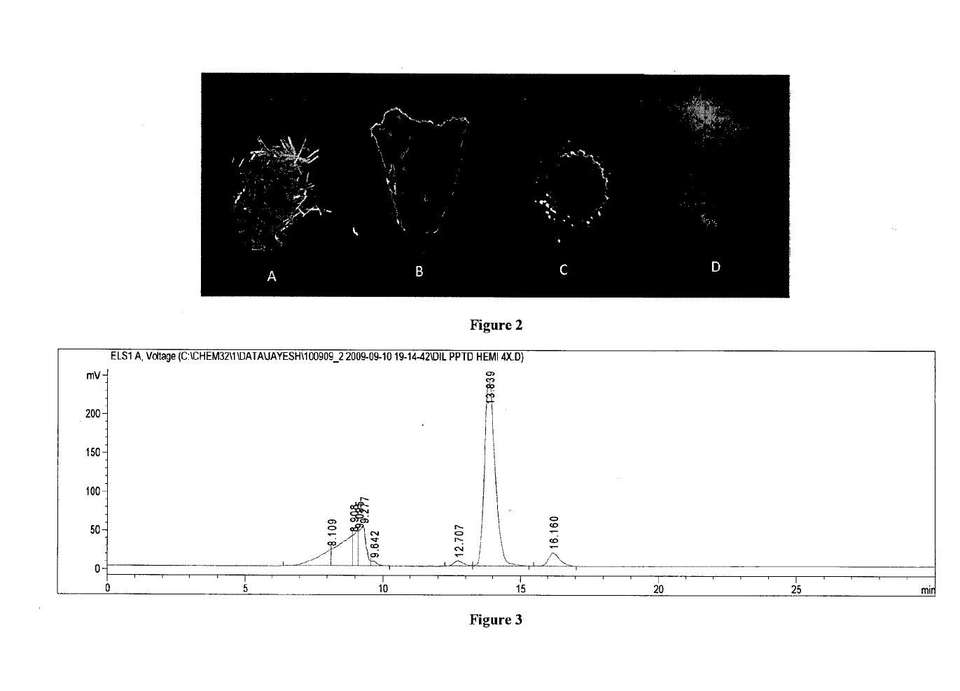

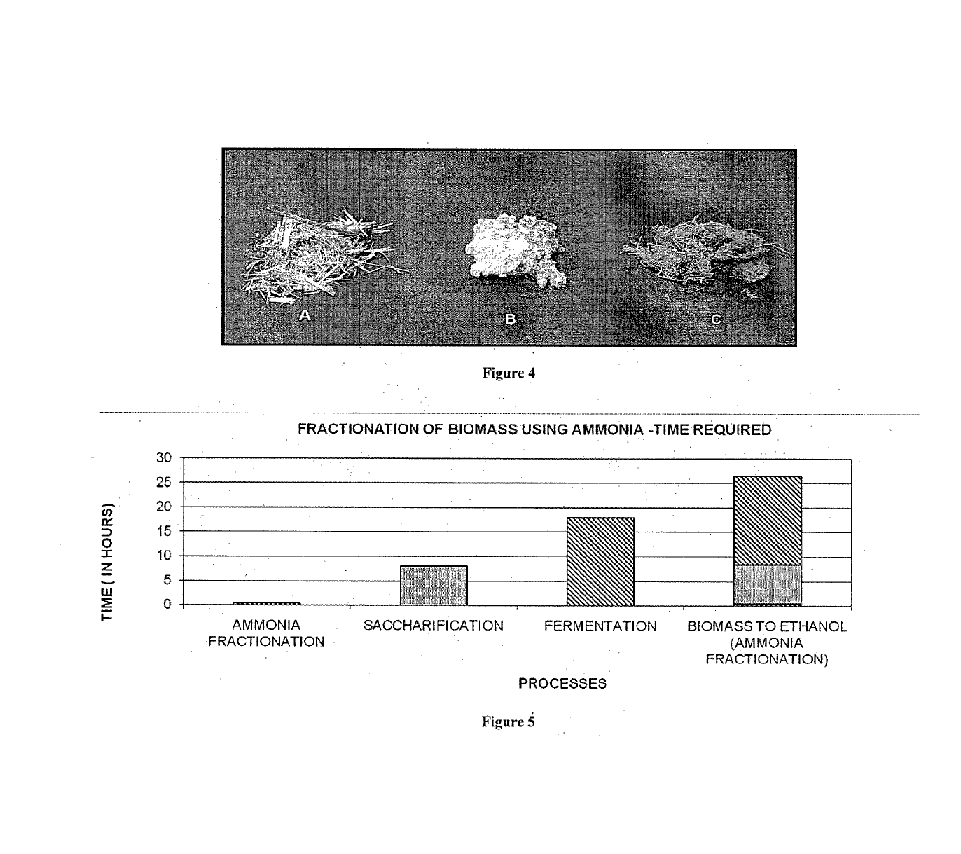

The physical observation of cellulose from rice straw after ammonia fractionation indicated that it having lighter colour and superior texture as compared to steam exploded cellulose which is darker in colour indicating some charring of biomass. (FIG. 4) The hemicellulose form a light beige powder when precipitated and dried (FIG. 2). Further compositional analysis of Hemicellulose obtained from rice straw shows Glucose (RT-12.7 min), Xylose (RT-13.6 min) and Arabinose (RT-16.1 min) peaks. Xylose (84% w/w total sugars) is the major component of rice straw hemicellulose followed by arabinose (16% w/w total sugars) and glucose (4% w/w total sugars) (FIG. 3)

The cellulose as well as cellulose+hemicellulose residue from rice straw after ammonia fractionation are highly amenable to enzymatic saccharification giving conversions (w.r.t to substrate solubilization) of over 95% in under 8 hours which is much faster when compared to standard substrate such as Whatman filter paper (Table 1)

### Continuous Mode

Rice straw after appropriate size reduction (to average 5 mm length) was mixed with 30% v/v liquid ammonia in a feed vessel to obtain the rice straw slurry. The slurry (3.5% w/v solids) was passed through a continuous high pressure reactor maintained at 125° C., wherein the residence time of the slurry in the reactor was 30 minutes. The product slurry was passed through an inline cooler where the slurry was cooled to 90° C. The slurry was then flashed into the first flash tank to release ammonia that was recovered and recycled. The product slurry from the bottom of the flash vessel was filtered to obtain residue comprising hemicelluloses and cellulose, and filtrate comprising lignin.

The residue obtained in the above step was mixed with water in another feed vessel. Resulting slurry stream and a known quantity of liquefied anhydrous ammonia added to make the resultant liquid ammonia concentration 60% v/v, were together passed through a continuous high pressure reactor maintained at 125° C., wherein the residence time of the slurry in the reactor was 30 minutes. Subsequently the slurry was passed through an inline cooler where temperature of the slurry was reduced to 90° C. The slurry was flashed into the second flash tank to release out ammonia that was recovered and the slurry was filtered to obtain residue comprising cellulose; and filtrate comprising hemicellulose

### Example 2

### Fractionation of Wheat Straw in to Cellulose, Hemicellulose and Lignin Using Aqueous Ammonia

### Batch Mode

Size reduced wheat straw (average 5 mm length; 3.5 g) was mixed with 100 ml of 30% v/v liquid ammonia in water, at 15° C. The resultant wheat straw-ammonia slurry was charged into a high pressure reactor. The reaction was carried out in the reactor vessel at 125° C. for 30 minutes to obtain first slurry. Temperature of the first slurry was reduced to at least 95° C. and filtered to obtain a first filtrate comprising lignin and a first residue comprising cellulose and hemicellulose. The first residue thus obtained was treated with 60% v/v liquid ammonia in water at 125° C. for 30 minutes to obtain second slurry. Temperature of the second slurry was reduced to at least 95° C. and filtered to obtain a second filtrate comprising hemicelluloses and a second residue comprising cellulose.

### Example 3

### Production of Soluble Sugars from Rice Straw

### Batch Mode: Biological Means

Size reduced rice straw (average 5 mm length; 3.5 g,) was mixed with 100 ml of 30% v/v liquid ammonia in water, at 15° C. The resultant rice straw-ammonia slurry was charged into a high pressure reactor. The reaction was carried out in the reactor vessel at 125° C. for 30 minutes to obtain first slurry. Temperature of the first slurry was reduced to at least 95° C. and subsequently the slurry was filtered to obtain a first filtrate comprising lignin and a first residue comprising cellulose and hemicellulose. The first residue thus obtained was treated with 60% v/v liquid ammonia in water at 125° C. for 30 minutes to obtain the second slurry. Temperature of the second slurry was reduced to at least 95° C. and the subsequently the slurry was filtered to obtain a second filtrate comprising hemicelluloses and a second residue comprising cellulose.

The second residue comprising cellulose was suspended in acidified water (pH 5) and was treated with a mixture of endo- and exo-glucanases (100 IU enzyme/gram of residue) at 50° C. Complete conversion of cellulose to glucose was obtained within 8 hours. The glucose so obtained can be used for the production of ethanol, butanol, hydroymethyl furfural, lactic acid, acetic acid etc. using chemical and/or biological means.

The second filtrate comprising of hemicellulose was acidified to a pH 5 and was treated with hemicellulases (100 IU enzyme/gram of hemicellulose) at 50° C. Complete conversion of hemicellulose to xylose, arabinose and glucose was obtained within 8 hours. The xylose, arabinose and glucose so formed could be used for the production of desired compounds such as ethanol, lactic acid, furfural by chemical and/or biological means.

### Continuous Mode: Biological Means

Rice straw after appropriate size reduction (to average 5 mm length) was mixed with 30% v/v liquid ammonia in a feed vessel to obtain the rice straw slurry. The slurry (3.5% w/v solids) was passed through a continuous high pressure reactor maintained at 125° C., wherein the residence time of the slurry in the reactor was 30 minutes. The product slurry was passed through an inline cooler where the slurry was cooled to 90° C. The slurry was then flashed into the flash tank to release ammonia that was recovered and recycled. The product slurry from the bottom of the flash vessel was filtered to obtain residue comprising hemicelluloses and cellulose, and filtrate comprising lignin.

The residue comprising of cellulose and hemicellulose was then suspended in 300 mL of 50 mM citrate buffer pH 4.8 and was treated with a of mixture of endo- and exo-glucanases (100 IU enzyme/gram of residue) in a membrane reactor assembly at 50° C. The reactor assembly consisted of a stirred tank reactor (500 mL) equipped with a peristaltic pump that circulated the reaction mass through a tubular ultrafiltration membrane system (5 KDa and 0.01 square meter). The retentate from the membrane system was sent back to the stirred tank while the permeate was analyzed for glucose and xylose content. A 95% conversion of residue to monosugars i.e. glucose and xylose was found to occur on continuous steady state basis. Desired compounds such as ethanol, lactic acid, and furfural can be produced from glucose and xylose by chemical and/or biological means.

### Continuous Mode: Chemical Means

Rice straw after appropriate size reduction (to average 5 mm length) was mixed with 30% v/v liquid ammonia in a feed vessel to obtain the rice straw slurry. The slurry (3.5% w/v solids) was passed through a continuous high pressure reactor maintained at 125° C., wherein the residence time of the slurry in the reactor was 30 minutes. The product slurry was passed through an inline cooler where the slurry was cooled to 90° C. The slurry was then flashed into the first flash tank to release ammonia that was recovered and recycled. The product slurry from the bottom of the flash vessel was filtered to obtain residue comprising hemicelluloses and cellulose, and filtrate comprising lignin.

The residue obtained in the above step was mixed with water in another feed vessel. Resulting slurry stream and a known quantity of liquefied anhydrous ammonia (to make the resultant liquid ammonia concentration 60% v/v) were together passed through a continuous high pressure reactor maintained at 125° C., wherein the residence time of the slurry in the reactor was 30 minutes. Subsequently the slurry was passed through an inline cooler where temperature of the slurry was reduced to 90° C. Afterwards the slurry was flashed into the first flash tank to release out ammonia that was recovered and the slurry was filtered to obtain residue comprising cellulose and filtrate comprising hemicellulose

The second residue comprising cellulose was mixed with acidified water in another feed vessel. The resulting slurry stream was passed through a continuous high pressure tubular Hastelloy reactor maintained at 200° C., wherein the residence time of the slurry in the reactor was 90 seconds. Subsequently the reacted slurry (now a glucose solution) was passed through an inline cooler where temperature of the solution was reduced rapidly to 60° C. The glucose solution can be concentrated by known methods such as nanofiltration or distillation to obtain pure glucose.

The second filtrate comprising hemicellulose was mixed with acidified water in another feed vessel. The resulting solution stream was passed through a continuous high pressure tubular Hastelloy reactor maintained at 170° C., wherein the residence time of the solution in the reactor was 60 seconds. Subsequently the reacted solution was passed through an inline cooler where temperature of the solution was reduced rapidly to 60° C. It was found that the resulting solution contains 84% (w/w total sugars) xylose, 16% arabinose (w/w total sugars) and 4% glucose (w/w total sugars)

### Example 4

### Ethanol Production from Rice Straw

### Batch Mode

Size reduced rice straw (average 5 mm length); was mixed with 1 of 30% v/v liquid ammonia in water (3.5% w/v solids), at 15° C. The resultant rice straw-ammonia slurry was charged into a high pressure reactor. The reaction was carried out in the reactor vessel at 125° C. for 30 minutes to obtain first slurry. Temperature of the reacted slurry was reduced to at least 95° C. and subsequently the slurry was filtered to obtain a filtrate comprising lignin and a residue comprising cellulose and hemicellulose.

The residue was suspended in acidified water (pH 5) and was hydrolyzed with a of mixture of endo- and exo-glucanases (100 IU enzyme/gram of residue) at 50° C. Complete conversion of polysaccharides to glucose and xylose was obtained within 8 hours. The resulting hydrolyzate was ultrafiltered using a 5 KDa membrane to recover the enzyme and the protein free hydrolyzate was then concentrated using vacuum distillation to get final soluble sugar (glucose+xylose) concentration of 10% (w/v).

100 ml the hydrolyzate was pasteurized after supplementing it with yeast extract (0.25%) and subjected to co-fermentation using a glucose fermenting yeast (Sacchromyces sp.) and a pentose fermenting yeast (Pichia stipitis) in a 500 ml. Erlenmeyer flask with constant agitation of 150 rpm at 30° C. A yield of 0.46 g ethanol/g of sugars was achieved within 18 hours.

### Continuous Mode

Rice straw after appropriate size reduction (to average 5 mm length) was mixed with 30% v/v liquid ammonia in a feed vessel to obtain the rice straw slurry. The slurry (3.5% w/v solids) was passed through a continuous high pressure reactor maintained at 125° C., wherein the residence time of the slurry in the reactor was 30 minutes. The product slurry was passed through an inline cooler where the slurry was cooled to 90° C. The slurry was then flashed into the first flash tank to release ammonia that was recovered and recycled. The product slurry from the bottom of the flash vessel was filtered to obtain residue comprising hemicelluloses and cellulose, and filtrate comprising lignin.

The residue obtained in the above step was mixed with water in another feed vessel. Resulting slurry stream and a known quantity of liquefied anhydrous ammonia (to make the resultant liquid ammonia concentration 60% v/v) were together passed through a continuous high pressure reactor maintained at 125° C., wherein the residence time of the slurry in the reactor was 30 minutes. Subsequently the slurry was passed through an inline cooler where temperature of the slurry was reduced to 90° C. Afterwards the slurry was flashed into the first flash tank to release out ammonia that was recovered and the slurry was filtered to obtain residue comprising cellulose and filtrate comprising hemicellulose.

The second residue comprising cellulose was then suspended in 300 mL of acidified water (pH 5) and was treated with a of mixture of endo- and exo-glucanases (100 IU enzyme/gram of residue) in a membrane reactor assembly at 50° C. The reactor assembly consisted of a stirred tank reactor (500 mL) equipped with a peristaltic pump that circulated the reaction mass through a tubular ultrafiltration membrane system (5 KDa and 0.01 square meter). The retentate from the membrane system was sent back to the stirred tank while the permeate (known as ‘glucose solution’ henceforth) was analyzed for glucose content. A 98% conversion of cellulose to glucose was found to occur on continuous steady state basis.

The glucose solution was concentrated to 20% (w/v) and was supplemented with yeast extract (0.25% w/v) and then pasteurized by passing it through a coiled metal loop immersed in a water bath maintained at 72° C. wherein the residence time of the permeate (known henceforth as medium) inside the heated loop was at least 30 seconds. The medium was then subjected to a continuous fermentation process using a glucose fermenting wine yeast (Sacchromyces sp.) in a jacketed Sartorius 2 L BioStat B+ fermentor equipped with automated temperature and pH control, and optical density (OD) probe. The initial volume of medium in the fermenter at 1.5 L, pH was maintained at 5.5 by addition of a base and temperature was maintained at 30° C. A dilution rate of 0.1 hr⁻¹ was maintained and samples were analyzed for ethanol content after establishment of steady state (determined by OD). Increased productivities of up to 5 g/l/hr of ethanol were obtained.

### Example 5

### Production of Phenolic Monomers from Rice Straw

Size reduced rice straw (average 5 mm length; 3.5 g,) was mixed with 100 ml of 30% v/v liquid ammonia in water, at 15° C. The resultant rice straw-ammonia slurry was charged into a high pressure reactor. The reaction was carried out in the reactor vessel at 125° C. for 30 minutes to obtain slurry. Temperature of the slurry was reduced to at least 95° C. and subsequently the slurry was filtered to obtain a filtrate comprising lignin and a residue comprising cellulose and hemicellulose.

The resulting slurry was acidified to pH 3 using a mineral acid and lignin from the resulting slurry was precipitated using a cationic polyelectrolyte solution (1% v/v). The precipitated lignin was separated by centrifugation for 10 minutes at 1000 g and kept for drying at 50° C. for 1 hour. 1 g of this lignin powder was treated with 2% (v/v) nitric acid at 130° C. for 30 minutes in high pressure autoclave. The resultant depolymerized lignin solution was extracted with chloroform (2 volumes) for 15 minutes to extract phenolic monomers such as p-coumaryl alcohol, syringaldehyde, synapyl alcohol and vanillin which can be used as a fuel additive or can find uses in the fine chemicals industry.

TABLE 1
Biomass enzyme amenability tests demonstrating the superior amenability
of Cellulose as well as Cellulose + Hemicellulose mixture obtained after ammonia
fractionation process of rice straw in comparison with commercial samples of steam
exploded and standard (Whatman Filter Paper No. 1) celluloses.

| | | Cellulase 100 U/g | % Conversion | |
|---|---|---|---|---|
| | | of substrate | w.r.t. | |
| S. | Substrate | pH 5.5 | solubilization | Time |
| No. | (Biomass type) | Temperature 50° C. | of substrate | (Hours) |
| 1 | Cellulose obtained from | | >95 | 8 |
| | ammonia fractionation | | | |
| | process | | | |
| 2 | Cellulose + Hemicellulose | | >95 | 8 |
| | obtained from ammonia | | | |
| | fractionation process | | | |
| 3 | Cellulose (Steam treated) | | 18.15 | 8 |
| 4 | Whatman Filter Paper No.1 | | 47.8 | 8 |

TABLE 2
Ammonia fractionation of rice straw- Fractionation efficiency w.r.t. to
lignin content (as determined by analysis of solid biomass residues at different
stages using standard NREL LAP protocols for analysis of biomass)

| | | Lignin | Lignin Removal % |
|---|---|---|---|
| S. | | Content (% | w.r.t. initial lignin content in |
| No. | Biomass/Residue type | w/w ) | untreated rice straw |
| 1 | Rice straw (untreated) | 14.0 | Not applicable |
| 2 | Cellulose and Hemicellulose obtained | 1.5 | >90 |
| | from ammonia fractionation process | | |

1. A process of fractionation of biomass to obtain lignin, cellulose and hemicelluloses, the process comprising:
a. contacting the biomass with 5% to 30% (v/v) aqueous ammonia at a temperature ranging from 50° C. to 200° C. to obtain a first biomass slurry;
b. filtering the first biomass slurry to obtain a first filtrate comprising lignin and a first residue comprising cellulose and hemicellulose;
c. contacting the first residue with 30% to 90% (v/v) aqueous ammonia at a temperature ranging from 50° C. to 200° C. to obtain a second biomass slurry; and
d. filtering the second biomass slurry to obtain a second filtrate comprising hemicelluloses and a second residue comprising cellulose.

2. A process of fractionation of biomass to obtain cellulose and hemicelluloses, the process comprising:
a. contacting the biomass with 5% to 90% (v/v) aqueous ammonia at a temperature ranging from 50° C. to 200° C. to obtain a biomass slurry; and
b. filtering the biomass slurry to obtain a filtrate comprising hemicellulose and a residue comprising cellulose and/or hemicellulose.

3. The process of claim 2, wherein the filtrate comprises lignin.

4. The process of claim 2, wherein pH of the biomass slurry is 8-14.

5. The process of claim 3, wherein the lignin is precipitated with one or more polyelectrolyte selected from a group consisting of natural polymers, synthetic polymers and semi-synthetic polymers, electrolytes and acids.

6. The process of claim 5, wherein the electrolytes are selected from a group consisting of anionic, cationic, non-ionic, organic, and inorganic compounds.

7. The process of claim 1, wherein the biomass is selected from a group consisting of rice straw, wheat straw, cotton stalks, sugarcane bagasse, sorghum bagasse, corn cobs, corn stalks, corn stover, corn plant, castor stalks, water hyacinth, forest waste, paper waste, and grasses, switch grass, elephant grass, Miscanthus, corn grains, corn bran, wheat grains, wheat bran, rice grains, rice bran, maize grains, sorghum grains, pearl millet grains, and rye grains.

8. The process of claim 2, wherein the biomass is non-lignocellulosic biomass.

9. The process of claim 8, wherein the non-lignocellulosic biomass is selected from a group consisting of paper, paper waste, microbial cell mass, macroalgae cell mass, and macroalgae biomass.

10. The process of claim 2, wherein weight of the biomass is 0.5% to 25% (w/v) in the aqueous ammonia.

11. The process of claim 2, wherein retention time of the biomass in the aqueous ammonia is 1 to 120 minutes.

12. The process of claim 2, wherein retention time of the biomass in the aqueous ammonia is 5 to 30 minutes.

13. The process of claim 1, wherein retention time of the first residue in the aqueous ammonia is 1 to 120 minutes, preferably 5 to 30 minutes.

14. The process of claim 2, wherein at least 90% lignin, at least 91% cellulose, and at least 85% hemicellulose is obtained from the biomass.

15. A process of saccharification of biomass to produce soluble sugars, the process comprising:
a. contacting the biomass with 5% to 30% (v/v) aqueous ammonia at a temperature ranging from 50° C. to 200° C. to obtain a first biomass slurry;
b. filtering the first biomass slurry to obtain a first filtrate comprising lignin and a first residue comprising cellulose and hemicellulose;
c. treating the first residue with 30% to 90% (v/v) aqueous ammonia at a temperature ranging from 50° C. to 200° C. to obtain a second biomass slurry;
d. filtering the second biomass slurry to obtain a second filtrate comprising hemicellulose and a second residue comprising cellulose; and
e. hydrolyzing the cellulose and hemicellulose obtained in step (d) to obtain soluble sugars.

16. A process of saccharification of biomass to obtain soluble sugars, the process comprising:
a. contacting the biomass with 5% to 90% (v/v) aqueous ammonia at a temperature ranging from 50° C. to 200° C. to obtain a biomass slurry;
b. filtering the biomass slurry to obtain a filtrate comprising hemicellulose; and a residue comprising cellulose and/or hemicellulose, and
c. hydrolyzing cellulose and/or hemicellulose obtained in step (b) to obtain soluble sugars.

17. The process of claim 16, wherein retention time of the biomass in the aqueous ammonia is 1 to 120 minutes.

18. The process of claim 1, wherein retention time of the first residue in the aqueous ammonia is 1 to 120 minutes, preferably 5 to 30 minutes.

19. The process of claim 16, wherein the sugars are selected from a group consisting of glucose, xylose, arabinose, mannose, rhamnose, cellobiose, and cellodextrins.

20. A process of production of desired compounds from biomass, the process comprising:
a. contacting the biomass with 5% to 30% (v/v) aqueous ammonia at a temperature ranging from 50° C. to 200° C. to obtain a first biomass slurry;
b. filtering the first biomass slurry to obtain a first filtrate comprising lignin and a first residue comprising cellulose and hemicellulose;
c. contacting the first residue with 30% to 90% (v/v) aqueous ammonia at a temperature ranging from 50° C. to 200° C. to obtain a second biomass slurry;
d. filtering the second biomass slurry to obtain a second filtrate comprising hemicelluloses and a second residue comprising cellulose;
e. hydrolyzing the cellulose and hemicellulose obtained in step (d) to obtain soluble sugars, and
f. converting the soluble sugars into desired compounds by chemical or biological means

21. The process of claim 20 further comprising converting lignin from step (b) into desired compounds.

22. The process of claim 21, wherein the desired compound is selected from the group consisting of toluene, benzene, vanillin, hydrocarbons, cresols, and phenols.

23. A process of production of desired compounds from biomass, the process comprising:
a. contacting the biomass with 5% to 90% (v/v) aqueous ammonia at a temperature ranging from 50° C. to 200° C. to obtain a biomass slurry;
b. filtering the biomass slurry to obtain a filtrate comprising hemicellulose; and a residue comprising cellulose and/or hemicellulose,
c. hydrolyzing cellulose and/or hemicellulose obtained in step (b) to obtain soluble sugars, and
d. converting the soluble sugars into desired compounds by chemical or biological means.

24. The process of claim 23, wherein the desired compound is selected from the group consisting of ethanol, methanol, propanol, butanediol, isopropanol, butanol, iso-butanol, glycerol, erythritol, xylitol, sorbitol, furfural, hydroxymethyl furfural, furfuryl alcohol, acetic acid, lactic acid, propionic acid, 3-hydroxypropionic acid, butyric acid, gluconic acid, itaconic acid, citric acid, succinic acid, levulinic acid, glutamic acid, aspartic acid, methionine, lysine, glycine, arginine, threonine, phenylalanine, tyrosine, methane, ethylene, and acetone.

25. The process of claim 23, wherein biological means is microbial and/or enzymatic biotransformation.

26. The process of claim 25, wherein the microbial biotransformation is carried out by using microorganisms selected from the group consisting of yeast, bacteria, and fungi.

27. The process of claim 26, wherein the microorganism is selected from a group consisting of E. coli, Saccharomyces cervisiae, Zymomonas mobilis, Pichia stiptis, Candida, Clostridium acetobutylicum, Acetobacter, Rhizopus oryzae, Lactobacillus, and Bacillus stearothermophilus.

28. The process of claim 23, further comprising recycling the ammonia.
